(19) United States
(12) Patent Application Publication
(10) Pub. No.: US 2006/0198962 A1
(43) Pub. Date: Sep. 7, 2006

(54) Method for producing extremely durable photographs and printed matter

(76) Inventor: Efim Kravetz, Petach Tikva (IL)

Correspondence Address: DR. MARK FRIEDMAN LTD.;c/o Bill Polkinghorn, 9003 Florin Way, Upper Marlboro, MD, 20772, US

(21) Appl. No.: 11/068,743

(22) Filed: Mar. 2, 2005

(51) Int. Cl. B05D 3/12

(52) U.S. Cl. 427/350

(57) ABSTRACT

A method of producing extremely durable printed matter by polymerization of the printed matter in a polymerization process with and between two sheets of preimpregnated fiber-reinforced polymer matrix. Another embodiment allows production of several pieces of work simultaneous.

### FIELD AND BACKGROUND OF THE INVENTION

The present invention relates to a method for producing extremely durable photographs and other printed matter and, more particularly, to a method for producing photographs and other printed matter that are highly resistant to environmental damage and destruction. For the purposes of this patent application, “printed matter” refers to any matter resulting from the application of colored media to a substrate including but not limited to any practice of impressing letters, characters, or figures on paper, cloth, or other material; or the act of producing photographic prints.

Printed matter is notorious for being vulnerable to damage and destruction caused by exposure to various natural and artificial environmental elements. The inks, dyes, and other media elements used to print printed matter on paper or other porous substrates and those substrates themselves decompose over time. The time it takes for the damage and destruction to occur can vary depending on the stability of the media elements and substrates used and the various laminates and other protective devices applied to the surfaces of the photographs and printed matter after they are printed.

Existing methods for protecting photographs and other printed matter usually involve the application of a protective laminate to one or both sides of the photograph or printed matter and may involve the application of those protective laminates using epoxy resins, heat or pressure or a combination thereof. The primary problem of these laminating methods is that the layers created on one or both sides of the photograph or printed matter either decompose or delaminate from the printed substrate. Other existing methods encase the photograph or other printed matter in a clear plastic or acrylic slab. The problem with the slab method is that the slab is thick and heavy and has almost no flexibility. The present invention overcomes these faults in the existing methods by creating a photograph or other printed matter on a porous substrate that is polymerized within the middle of two sheets of pre-impregnated fiber-reinforced polymer matrix to create a thin solid polymerized substance that bonds through the pores of the substrate, will not delaminate, is extremely stable to destructive environmental influences, is very light, and is very flexible.

There is thus a need for, and it would be highly advantageous to have, the present invention for producing photographs and other printed matter that are highly resistant to environmental damage and destruction.

### SUMMARY OF THE INVENTION

According to the present invention there is provided a method for producing a photograph or other printed matter that results in a final product composed of a sheet of porous substrate, stable printing media applied to one or both surfaces of the porous substrate, and two sheets of preimpregnated fiber-reinforced polymer matrix polymerized with each other and the printed porous substrate from each side of the porous substrate through the pores of the porous substrate. The present invention successfully addresses the shortcomings of the presently known configurations by producing a photograph or other printed matter that is a solid, but flexible, polymerized mass, which is extremely resistant to environmental damage.

The method of the present invention creates a three-piece “sandwich” of one sheet of preimpregnated fiber-reinforced polymer matrix on each side of a piece of porous printed matter. When the polymer matrix—printed matter—polymer matrix “sandwich” is subjected to appropriate conditions of high temperature and high vacuum pressure, the polymer matrices and porous printed matter all polymerize into one monolithic layer. Preimpregnated fiber-reinforced polymer matrices have previously been used for a variety of applications for manufacturing structurally rigid components used in industrial, sports and leisure, transportation and aerospace fields. Preimpregnated fiber-reinforced polymer matrices have not, however, previously been used for creating polymerized monoliths with printed matter for the purposes of protecting that printed matter from damaging conditions.

Photographs and printed matter produced using the method of the present invention have been subjected to many extreme environmental conditions and other natural and artificial physical conditions with no apparent damage. Such conditions include: immersion in solutions of sulphuric acid, hydrochloric acid, and azotic (nitric) acid for five minutes; placement in a 240 degree (Fahrenheit) oven for ten minutes; immersion in water at 100 degrees (Celsius) for 120 minutes and room temperature for 720 hours, and zero degrees (Celsius) for 4,320; storage in sand for 11,040 hours; storage underground for 15,500 hours; immersion in the Mediterranean Sea for 1,800 hours; and immersion in the Dead Sea for 1,800 hours.

According to features in preferred embodiments of the invention described below there is provided a method for producing extremely durable photographs and printed matter, which method includes: obtaining a photograph or other printed matter on a porous substrate; cleaning the printed matter to remove loose particulate matter; and polymerizing the printed matter with and between two sheets of preimpregnated fiber-reinforced polymer matrix.

### BRIEF DESCRIPTION OF THE DRAWINGS

The invention is herein described, by way of example only, with reference to the accompanying drawings, wherein:

FIG. 1 illustrates the lay-up resulting from the general process of method of the present invention;

FIG. 2 illustrates the ordering of the various components; and

FIG. 3 illustrates an additional embodiment of the present invention, which allows simultaneous polymerization of multiple product sandwiches.

### DESCRIPTION OF THE PREFERRED EMBODIMENTS

The present invention is of a method of producing photographs and other printed matter created using the application of colored media to porous substrates, which printed matter is polymerized with fiber-reinforced epoxy resins to create a single unitary piece of work. Specifically, the present invention can be used to produce photographs and other printed matter that are extremely resistant to environmental damage and destruction.

The principles and operation of the production method according to the present invention may be better understood with reference to the drawings and the accompanying description.

The general process of method of the present invention requires a detailed lay-up of the various layers of needed materials. First, the printed matter 10 is obtained, cleaned of particulate matter and dried. The processes for producing printed matter using colored media on porous substrates, cleaning said printed matter 10, and drying said printed matter 10 are well known in the art and need not be discussed further in this patent application except to state that the printed matter 10 should be printed on a porous substrate, cleaned of any loose particulate matter, smoothed and dried in a desiccator for a minimum of eight minutes. While several cleaning methods are available, by way of example only, one acceptable method of cleaning the photograph uses a Teknek roller to clean the surface from dust subsequent to the Teknek roller having been cleaned by using a Teknek paper after each cleaning swing.

Two substantially identical sheets of preimpregnated fiber-reinforced polymer matrix 21 and 22 are trimmed to dimensions of from five (5) to twenty (20) millimeters in excess of the dimension of the printed matter. Though many preimpregnated fiber-reinforced matrices are available, one example of an acceptable preimpregnated fiber-reinforced matrix is Prepreg, which is manufactured by Hexcel Corporation (Stamford, Conn.). The process for drying preimpregnated fiber-reinforced polymer matrices is well known in the art and need not be discussed further in this patent application.

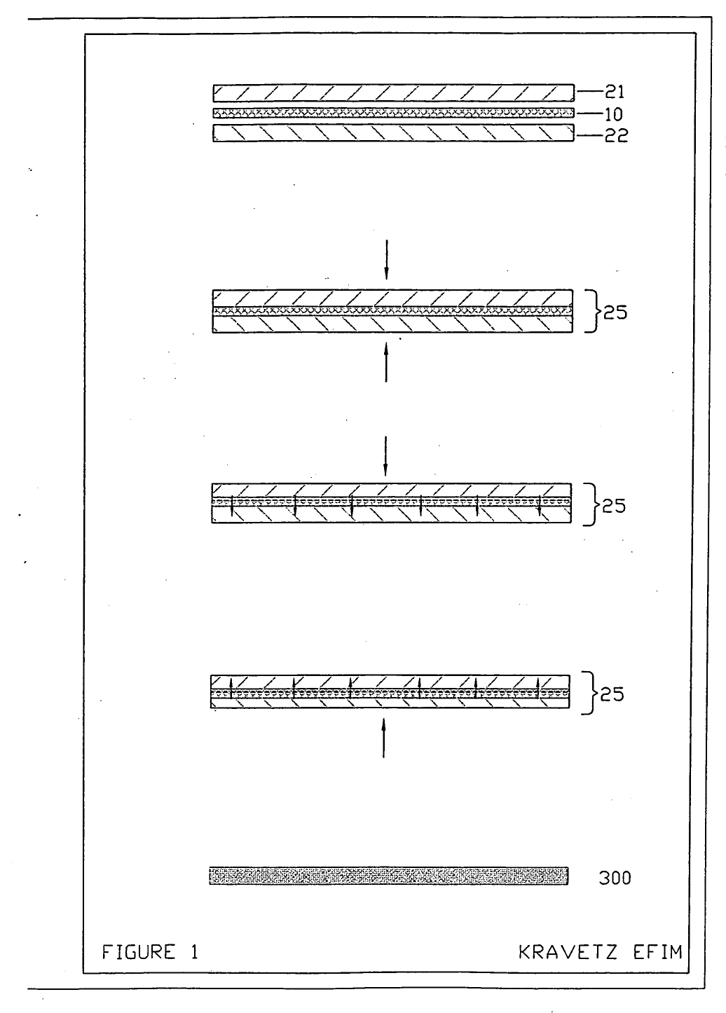

Referring now to the drawings, FIG. 1 illustrates the two substantially identical sheets of preimpregnated fiber-reinforced polymer matrix 21 and 22, which are placed in sandwich fashion on each side of the printed matter 10, for the purpose of providing polymer material for creation of an piece of work of extremely durable printed matter 300. The combination of the two sheets of preimpregnated fiber-reinforced polymer matrix 21 and 22 placed in sandwich fashion on each side of the printed matter 10 is sometimes herein referred to as a product sandwich 25. As illustrated in FIG. 1, this product sandwich, when subjected to heat and pressure in a vacuum autoclave, becomes one polymerized unit of extremely durable printed matter 300.

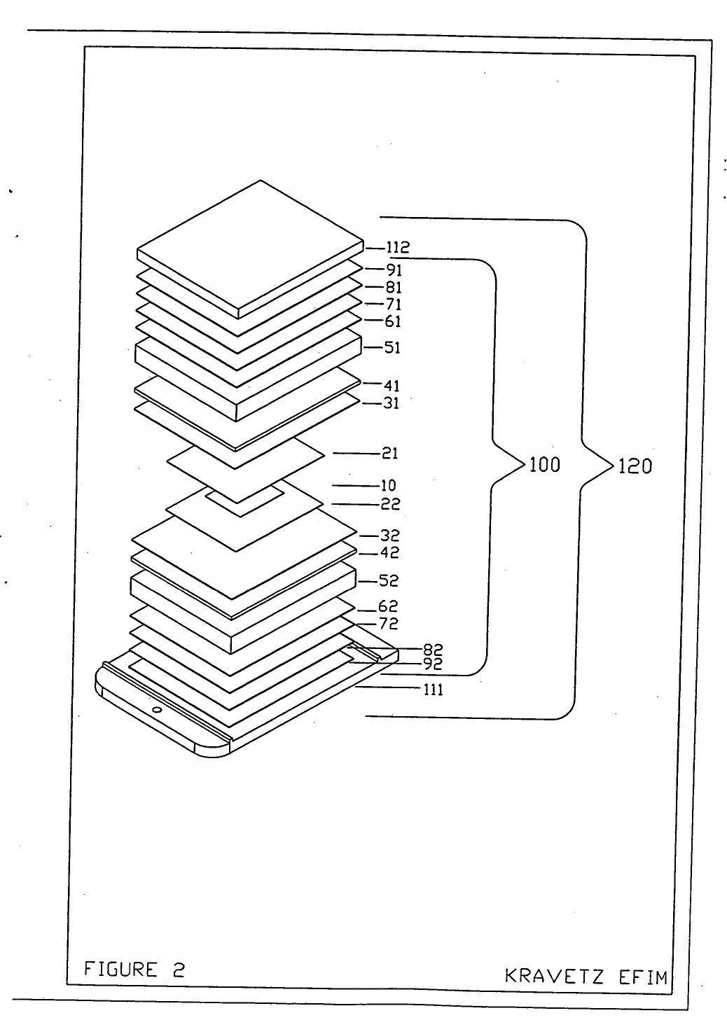

FIG. 2 illustrates the ordering of the various components needed to perform and control the polymerization reaction to create a single piece of work of extremely durable printed matter. Two substantially identical sheets of release film 31 and 32 are placed in sandwich fashion to the exterior of the product sandwich containing the printed matter 10 and preimpregnated fiber-reinforced polymer matrices 21 and 22, for the purpose of preventing adhesion of the sandwich to the more external layers. While the source and use of several release films are known in the art, by way of example only, two acceptable release films are Pacothane Release Film 1500 or 1200, which are manufactured by Pacothane Technologies, LLC, (1556 Third Ave., Suite 402, New York, N.Y. 10028).

Two steel separators 41 and 42 are washed and dried and placed in sandwich fashion to the exterior of the preceding sheets of release film 31 and 32 for the purpose of maintaining a smooth surface of the resulting product and for equalizing the heating and cooling of the polymerization process. The washing and drying and use of steel separators is well known in the art of working with preimpregnated fiber-reinforced polymer matrices and need not be discussed further in this patent application.

Two substantially identical steel plates 51 and 52 are placed in sandwich fashion to the exterior of the preceding two steel separators 41 and 42 for the purpose of maintaining the high temperature inside the package, to hold the package and even up the surface.

Two substantially identical sheets of release film 61 and 62 are placed in 20 sandwich fashion to the exterior of the preceding two steel plates 51 and 52 for the purpose of preventing adhesion of the sandwich to the more external layers. While several release films are known in the art, by way of example only, two acceptable release films are Pacothane Release Film 1500 or 1200, which are manufactured by Pacothane Technologies, LLC, 1556 Third Ave., Suite 402, New York, N.Y. 10028.

Two substantially identical sheets of 0.3-millimeter craft paper (also referred to in the art and hereinbelow as “blue paper”) 71 and 72 are placed in sandwich fashion to the exterior of the preceding sheets of release film 61 and 62 for the purpose of isolating the heat that will be applied to the package, so that the package won't over heat or heat too quickly, but rather will accumulate heat gradually, while not affecting the speed of the process.

Two substantially identical sheets of 0.2-millimeter craft paper (also referred to in the art and hereinbelow as “yellow paper”) 81 and 82 are placed in sandwich fashion to the exterior of the preceding sheets of blue paper 71 and 72 for the purpose of isolating the heat that will be applied to the package, so that the package won't over heat or heat too quickly, but rather will accumulate heat gradually, while not affecting the speed of the process.

Two substantially identical sheets of release film 91 and 92 are placed in sandwich fashion to the exterior of the preceding yellow papers 81 and 82, for the purpose of preventing adhesion of the sandwich to the more external layers.

Items 10, 21, 22, 31, 32, 41, 42, 51, 52, 61, 62, 71, 72, 81, 82, 91, and 92 are hereinafter collectively referred to as a single product sandwich package 100.

The single product sandwich package 100 is placed on an aluminum transport tray 111, for the purpose of allowing the transportation of the single product sandwich package during the polymerization process, and covered with an aluminum cover tray 112, for the purpose of equalizing the pressure applied during the polymerization process. The combination of the single product sandwich package 100, the aluminum transport tray 111 and the aluminum cover tray 112 are hereinafter referred to as a single product sandwich transport package 120.

The single product sandwich transport package 120 is placed in and operatively connected to an autoclave 200 and subjected to heat and vacuum pressure followed by a period of cooling in accordance with the recommendations of the manufacturer of preimpregnated fiber-reinforced polymer matrixes 21 and 22, for the purpose of bringing about the polymerization process and formation of the resulting extremely durable printed matter 300.

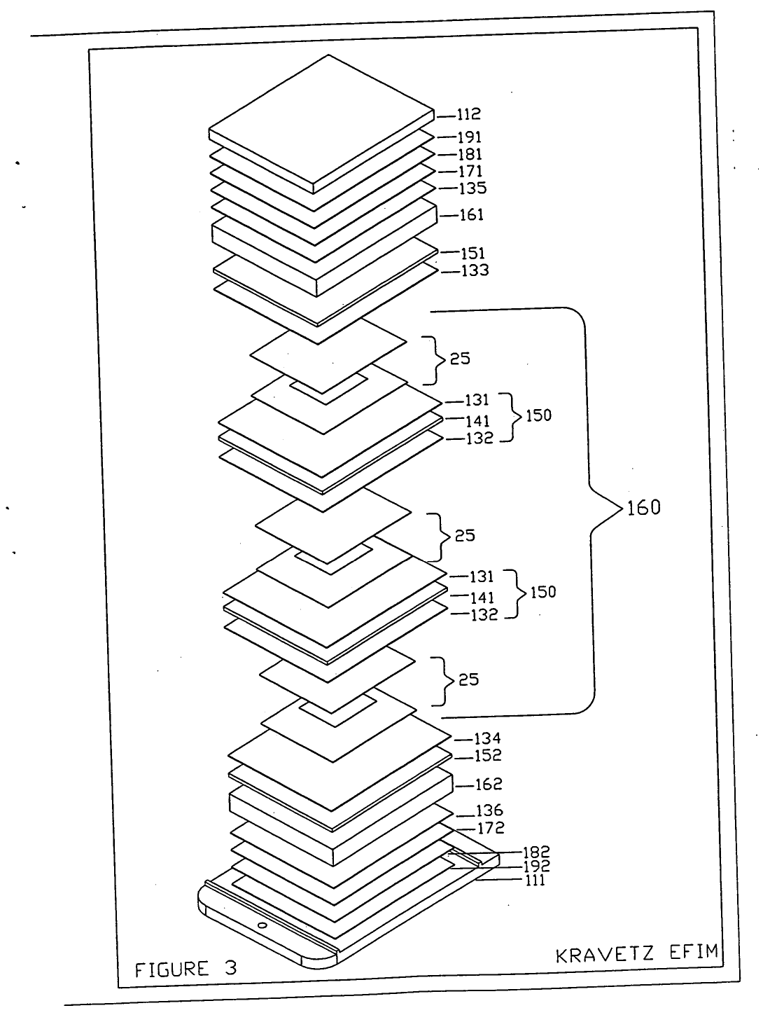

FIG. 3 illustrates an additional embodiment of the present invention, which allows simultaneous polymerization of multiple product sandwiches 25. In this multiple product sandwich embodiment an aluminum separator 141 is placed in sandwich fashion between two substantially similar sheets of release film 131 and 132 to create a separator sandwich 150. A plurality N of single product sandwich packages 100 are alternated with a plurality N+1 of separator sandwiches 150 to form a multiple product sandwich stack 160, which both begins and ends with a separator sandwich 150.

The multiple product sandwich stack 160 is placed in sandwich fashion between two sheets of release film 133 and 134, two steel separators 151 and 152, two steel plates 161 and 162, two more sheets of release film 135 and 136, and a plurality of sheets of blue paper 171 and yellow paper 181. The exact number of sheets of the blue paper 171 and yellow paper 181 being determined by the combined recommendations of the manufacturers the preimpregnated fiber-reinforced polymer matrices 21 and 22, the blue paper 171, the yellow paper 181, and the autoclave 200. The combination of the plurality of single product sandwich packages 100, with the plurality of separator sandwiches 150, blue papers 171, yellow papers 181 are collectively referred to as a multiple product sandwich package 190. The combination of various numbers of single product sandwich packages 100 with the corresponding numbers of separator sandwiches 150 and blue papers 171 and yellow papers 181 is either well-known in the art or can be obtained without undue experimentation and does not require additional discussion in this patent application.

The multiple product sandwich package 190 is first covered in sandwich fashion by two substantially identical pieces of release film 191 and 192 and then placed on an aluminum transport tray 111, for the purpose of allowing the transportation of the multiple product sandwich package 190 during the polymerization process, and covered with an aluminum cover tray 112, for the purpose of equalizing the pressure applied during the polymerization process. The combination of the multiple product sandwich package 190 aluminum transport tray 111 and the aluminum cover tray 112 are hereinafter referred to as a multiple product sandwich transport package 195.

The multiple product sandwich transport package 195 is placed in and operatively connected to an autoclave 200 and subjected to heat and vacuum pressure followed by a period of cooling in accordance with the recommendations of the manufacturer of preimpregnated fiber-reinforced polymer matrixes 21 and 22, for the purpose of bringing about the polymerization process and formation of the resulting extremely durable printed matter 300.

In another embodiment of the present invention the polymerization process occurs in a vacuum bag device instead of an autoclave. The use of vacuum bag devices to work with preimpregnated fiber-reinforced polymer matrices is well known in the art and need not be further discussed in this patent application.

While the invention has been described with respect to a limited number of embodiments, it will be appreciated that many variations, modifications and other applications of the invention may be made.

What is claimed is:

1. A method for producing extremely durable photographs and printed matter, said method comprising:
a. obtaining a photograph or other printed matter using colored media on a porous substrate;
b. cleaning the printed matter to remove loose particulate matter; and
c. polymerization of the printed matter in a polymerization process with and between two sheets of preimpregnated fiber-reinforced polymer matrix.

2. The method of claim 1 further comprising
a. placing said printed matter in sandwich fashion between said two two sheets of preimpregnated fiber-reinforced polymer matrix to create a product sandwich;
b. placing said product sandwich in a pair sequential sandwich fashion between two sheets of release film, two steel separators, two steel plates, a second two sheets of release film, two sheets of first craft paper, two sheets of second craft paper whose thickness are less than that of said first craft paper, and a third two sheets of release film to create a single product sandwich package;
c. placing said single product sandwich package on an aluminum transport tray;
d. covering said single product sandwich package placed on an aluminum transport tray with an aluminum cover tray to create a single product transport package;
e. placing said single product transport package in and operative connecting said single product transport package to an autoclave; and
f. subjecting said product sandwich to heat and vacuum pressure to bring about a polymerization reaction of said printed matter with and between said two sheets of preimpregnated fiber-reinforced polymer matrix, resulting in the formation of extremely durable printed matter.

3. The method of claim 1 further comprising
a. placing said printed matter in sandwich fashion between said two two sheets of preimpregnated fiber-reinforced polymer matrix to create a product sandwich;
b. placing said product sandwich in a paired sequential sandwich fashion between two sheets of release film, two steel separators, two steel plates, a second two sheets of release film, two sheets of first craft paper, two sheets of second craft paper whose thickness are less than that of said first craft paper, and a third two sheets of release film to create a single product sandwich package;
c. placing said single product sandwich package on an aluminum transport tray;
d. covering said single product sandwich package placed on an aluminum transport tray with an aluminum cover tray to create a single product transport package;
e. placing said single product transport package in and operatively connecting said single product transport package to a vacuum bag device; and
f. subjecting said product sandwich to heat and vacuum pressure to bring about a polymerization reaction of said printed matter with and between said two sheets of preimpregnated fiber-reinforced polymer matrix, resulting in the formation of extremely durable printed matter.

4. The method of claim 1 further comprising:
a. obtaining a third sheet of preimpregnated fiber-reinforced polymer matrix having an active side and an inactive side;
b. obtaining a decorative or descriptive frame of width and height slightly smaller than said extremely durable printed matter;
c. placing said third sheet of preimpregnated fiber-reinforced polymer matrix with said active side up;
d. placing said decorative or descriptive frame face down on the active side of said third sheet if preimpregnated fiber-reinforced polymer matrix;
e. placing said extremely durable printed matter face down on the back of said decorative or descriptive frame, for the purpose of creating a framed product sandwich;
f. placing said framed product sandwich between two sheets of release film, two steel separators, two steel plates, a second two sheets of release film, two sheets of first craft paper, two sheets of second craft paper whose thickness is less than that of said first craft paper, and a third two sheets of release film to create a framed product sandwich package
g. placing said framed product sandwich package on an aluminum transport tray;
h. covering said framed product sandwich package placed on said aluminum transport tray with an aluminum cover tray to create a framed product transport package; and
i. subjecting said framed product sandwich package to heat and vacuum pressure to bring about a polymerization reaction of said frame with and between said extremely durable printed matter and said third sheet of preimpregnated fiber-reinforced polymer matrix, resulting in the formation of extremely durable framed printed matter.

5. The method of claim 1 further comprising:
a. placing said printed matter in sandwich fashion between said two sheets of preimpregnated fiber-reinforced polymer matrix to create a single product sandwich package;
b. obtaining an aluminum separator;
c. placing said aluminum in sandwich fashion between two substantially similar sheets of release film to create a separator sandwich;
d. placing a plurality N of single product sandwich packages alternated with a plurality N+1 of separator sandwiches to form a multiple product sandwich stack, which both begins and ends with a separator sandwich;
e. placing said multiple product sandwich stack in sandwich fashion between two sheets of release film, two steel plates, two more sheets of release film, and a plurality of sheets of craft paper for the purpose of creating a multiple product sandwich package;
f. placing said multiple product sandwich package on an aluminum transport tray, for the purpose of allowing the transportation of the multiple product sandwich package during the polymerization process;
g. covering said multiple product sandwich package with an aluminum cover tray, for the purpose of equalizing the pressure applied during the polymerization process;
h. placing and connecting the combination of said multiple product sandwich package, said aluminum transport tray, and said aluminum cover tray in and operatively connected to an autoclave; and
i. subjecting said sandwich package to heat and vacuum pressure followed by a period of cooling, for the purpose of bringing about the polymerization process and formation of the resulting extremely durable printed matter.
